(19) United States
(12) Patent Application Publication
(10) Pub. No.: US 2009/0311582 A1
(43) Pub. Date: Dec. 17, 2009

(54) VENTING PLUG FOR STATIONARY BATTERIES, WITH BLAST-RESISTANT PROTECTION AND UNLIMITED, AUTOMATIC TOPPING-UP SYSTEM, AND TOPPING-UP ASSEMBLY EMPLOYING SAID PLUG

(75) Inventor: Angelo SAMPELLEGRINI, Pandino (Cremona) (IT)

Correspondence Address: YOUNG & THOMPSON, 209 Madison Street, Suite 500, Alexandria, VA, 22314, US

(73) Assignee: T.A.B.A. S.R.L., Pandino (Cremona) (IT)

(21) Appl. No.: 12/482,744

(22) Filed: Jun. 11, 2009

(30) Foreign Application Priority Data
Jun. 12, 2008 (EP) 08425416.8

(51) Int. Cl. H01M 2/12

(52) U.S. Cl. 429/64

(57) ABSTRACT

A venting plug for stationary batteries includes a support body, screwable into an upper opening of a battery element, provided with at least one topping-up hole intended to cause an electrolyte topping-up liquid introduced into the upper part of the support body to precipitate into the battery element, a porous element, mounted in the upper part of the support body, intended to act as a filtering barrier for gases rising up from the battery element towards the outside along the topping-up hole. The support body has inside a topping-up bowl, in communication with two inlet and outlet connections, provided with an upwardly-protruding conduit which opens below the bowl into an outlet nozzle, and below the bowl there is provided a hermetic closing element of the nozzle controlled by a float assembly which leads the closing element to obstruct the nozzle when the electrolyte level lies above a preset operational level

The present invention refers to a venting plug for batteries, in particular to a plug with anti-blasting protection.

As known, the batteries of stationary accumulators are fixed installations of electric batteries consisting of lead members immersed in an electrolytic solution. They are intended to supply, for example in case of emergency (typically discontinuation of the mains supply), electric appliances which need a uninterrupted power supply without variations or drops. They are normally employed in auxiliary services of power plant units and substations, in telephone and telegraph exchanges, in emergency light plants for public facilities, in emergency power plants for cableways and freight elevators, for continuous-cycle processes, to supply electronic computers or further to store electric power coming from photovoltaic systems (solar batteries).

A stationary battery of lead accumulators is connected in parallel to the electric mains it supports and consists of electrochemical elements, each having a conventional voltage (typically of about 2V). The number of elements, connected in series, determines the battery voltage value.

Each element may be built with planar or tubular plates. In the first case the plates consist of alloyed lead-antimony grids, with glass-fibre separators supporting the positive active matter and microporous polyethylene diaphragms. In the second case the positive plates are frames made of small pipes, consisting of sheaths containing active matter and permeable to electrolyte; the power is extracted through lead-alloy rheophores inside the tubular electrodes; in this case too the diaphragms between the plates are made of microporous polyethylene.

The electrolyte wherein the plates are immersed consists of a solution of sulphuric acid (density equal to 1.21-1.25 dm³ of electrolyte/dm³ of water).

In these accumulators, the free acid fills up to a preset level the hollow body of the element, consisting of a box container, normally made of clear SAN, closed above by a sealed cover and by a screwed-on or pushed-in, or bayonet-style fastened plug. The function of these plugs is also that of allowing the regular outflow of the hydrogen and oxygen released by the electrochemical process within the element.

The battery moreover is also electrically connected on one side to the circuit of the appliance (i.e. to the appliance requiring continuous power supply) and, on the other side, to a power rectifier (device capable of converting alternate current from the mains to continuous current suited to the accumulator characteristics).

If it is connected permanently to the circuit and to the rectifier, the battery is typically kept in buffer, in case it is connected alternately to the user and to the rectifier, the battery is in charging/discharging mode.

In any case, during the charging cycles, the electrolyte overheats and evaporates, releasing hydrogen and oxygen and causing a drop in the level of electrolyte solution.

Therefore, as known, the two-fold need exists to periodically top up the electrolyte level, as well as to manage the release of gases, preventing them from saturating the environment and causing detonation (hydrogen, in particular, is a highly explosive gas).

For such purpose, various plug configurations have already been suggested, which meet this two-fold need.

The object of the present invention is hence that of offering a plug with blast-resistant filter, for stationary batteries, which is simple and inexpensive, especially in the assembly thereof and in the mounting thereof on the battery, and which allows to reduce maintenance operations for electrolyte topping up.

Features and advantages of the device according to the invention will in any case be more evident from the following detailed description of some sample embodiments, given by way of example and shown in the accompanying drawings, wherein:

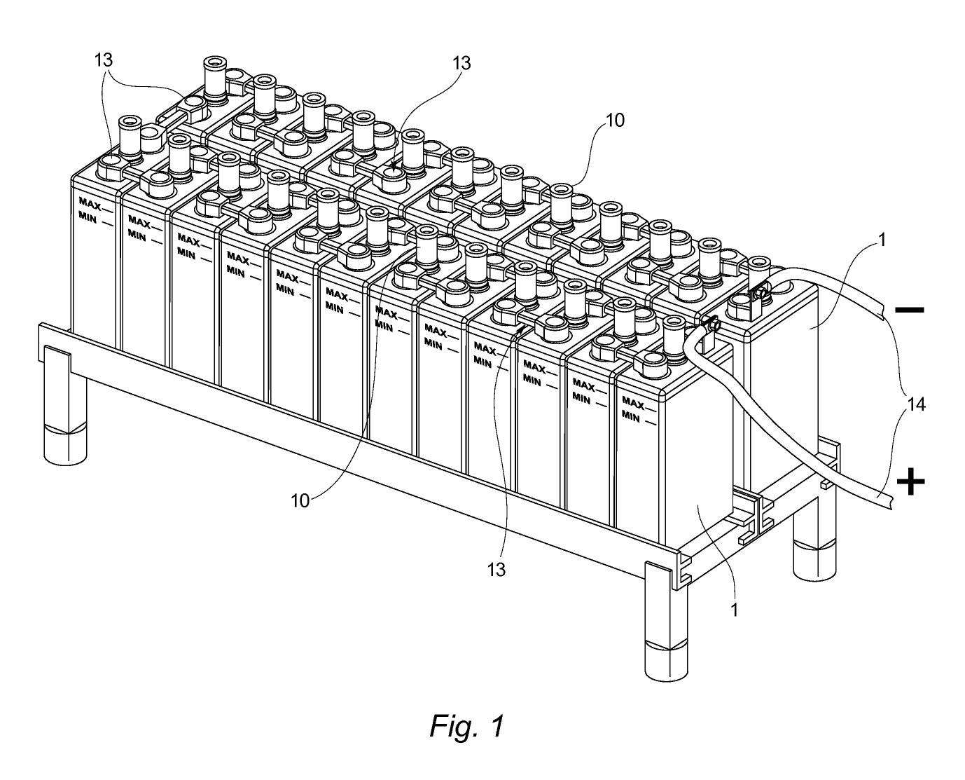

FIG. 1 is a perspective view of a battery of accumulators;

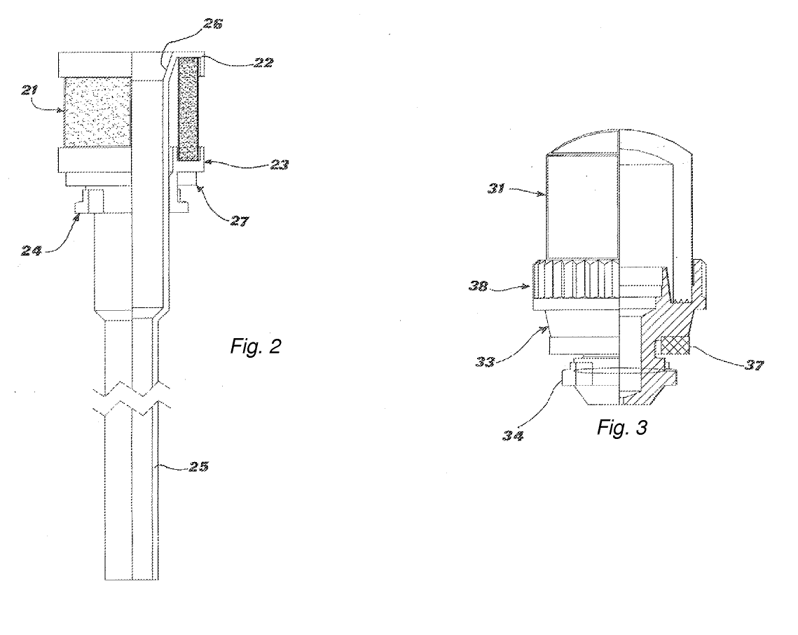

FIGS. 2 and 3 are partly-in-section, elevation views of two prior art plugs, with a cylindrical filter and with a dome-shaped filter, respectively;

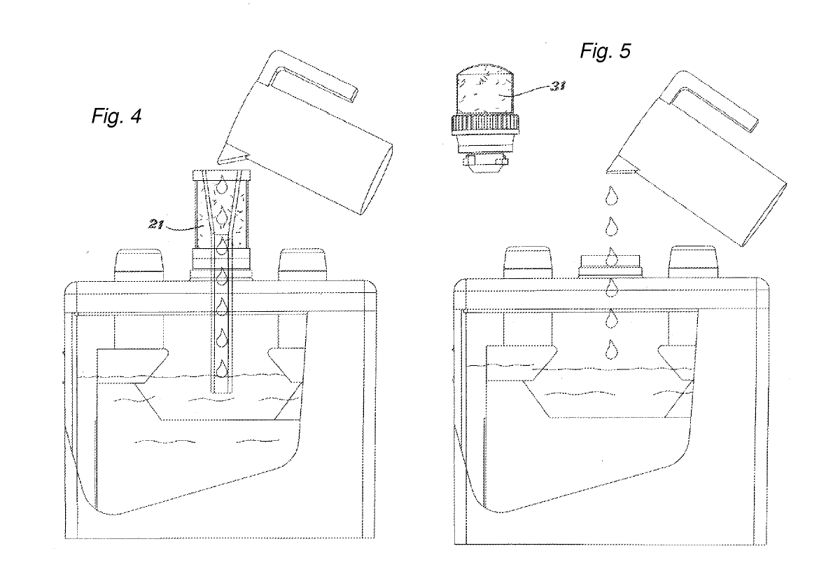

FIGS. 4 and 5 are side elevation views, partly showing-through, which show the prior-art topping-up modes with the two plugs of FIGS. 2 and 3;

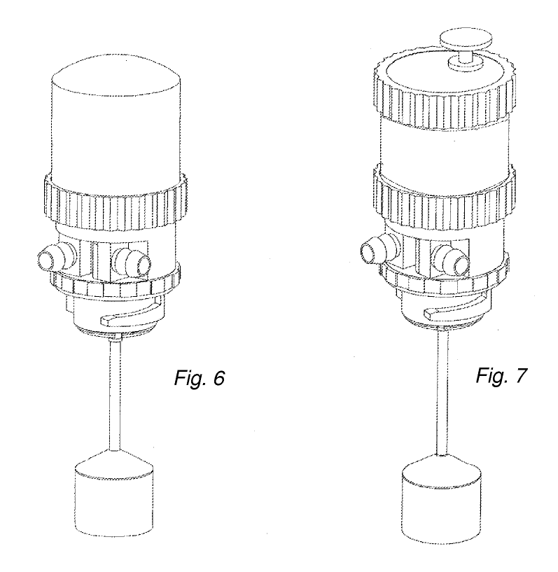

FIG. 6 is a perspective view of a plug with a dome-shaped filter according to the invention;

FIG. 7 is a perspective view of a plug with a cylindrical filter according to the invention;

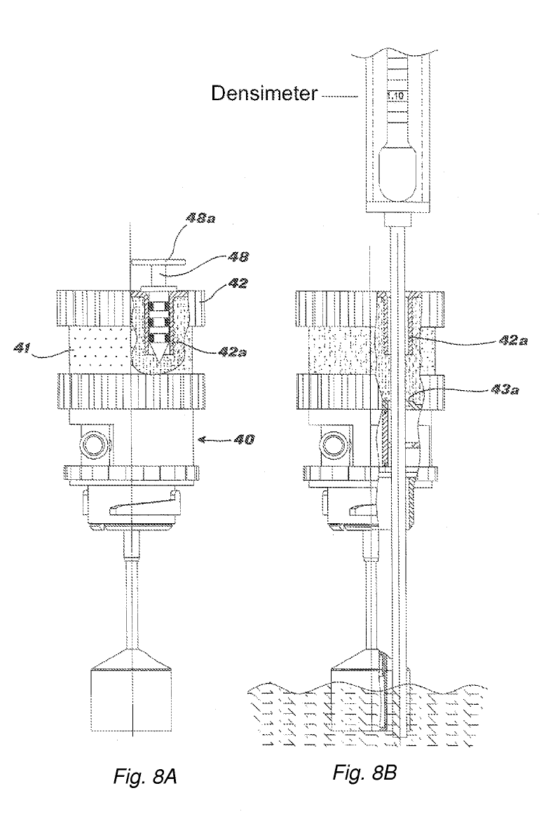

FIGS. 8A and 8B are front elevation views, partly in section, of the plug of FIG. 7 in two different operational states;

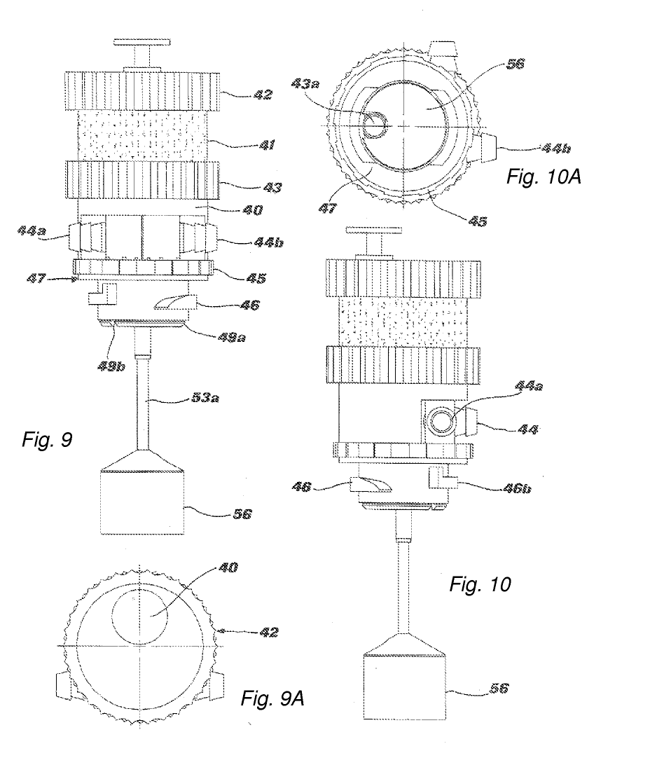

FIGS. 9, 9A, 10 and 10A are side elevation, top plan, front elevation and bottom plan views, respectively, of the plug of FIG. 7;

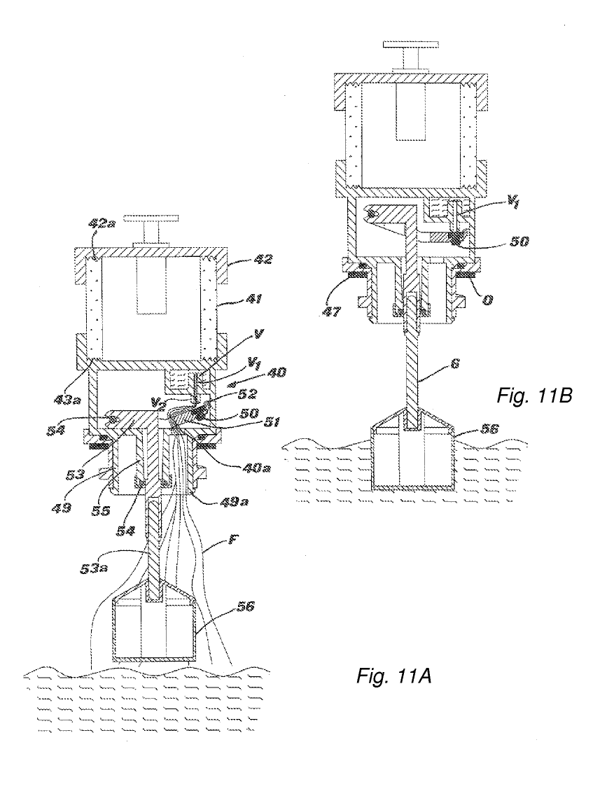

FIGS. 11A and 11B are longitudinal-section views in two operational states of the plug of FIG. 7;

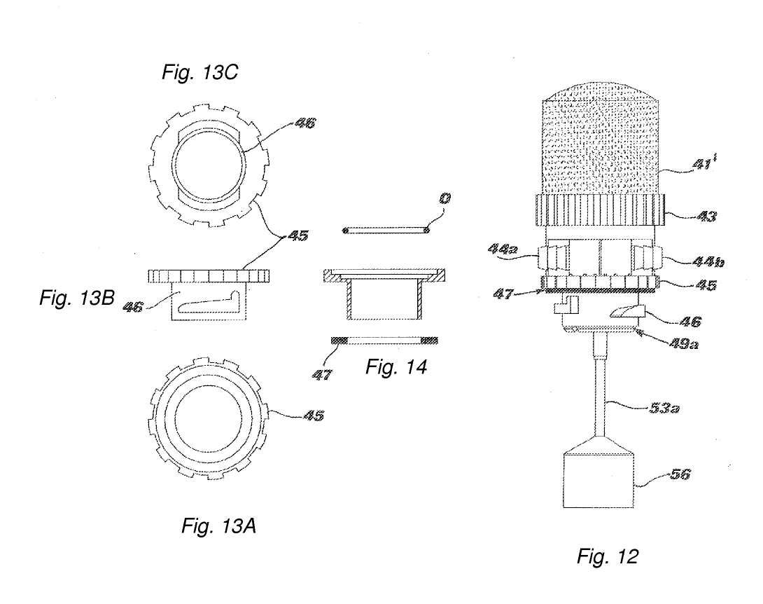

FIG. 12 is a side elevation view of a plug with a dome-shaped filter according to the invention;

FIGS. 13A-13C are top plan, side elevation and bottom plan views, respectively, of a cup element according to the invention;

FIG. 14 is an exploded section view of the cup element of FIG. 13B with the relative seals;

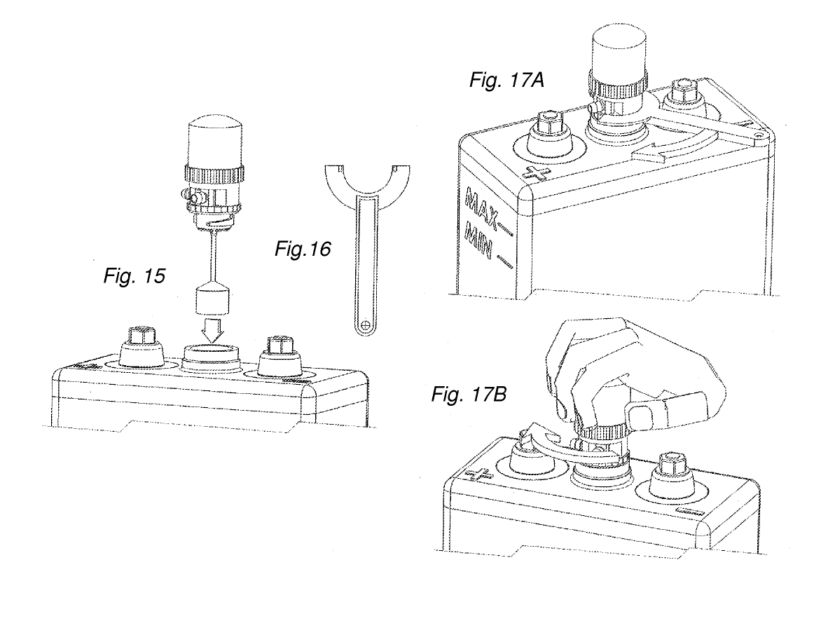

FIG. 15 is an interrupted, perspective view which shows the way of housing the plug according to the invention;

FIG. 16 is a diagrammatic view of a tightening key according to the invention;

FIGS. 17A and 17B are interrupted perspective views which show the tightening and then plug orientation procedure according to the invention; and

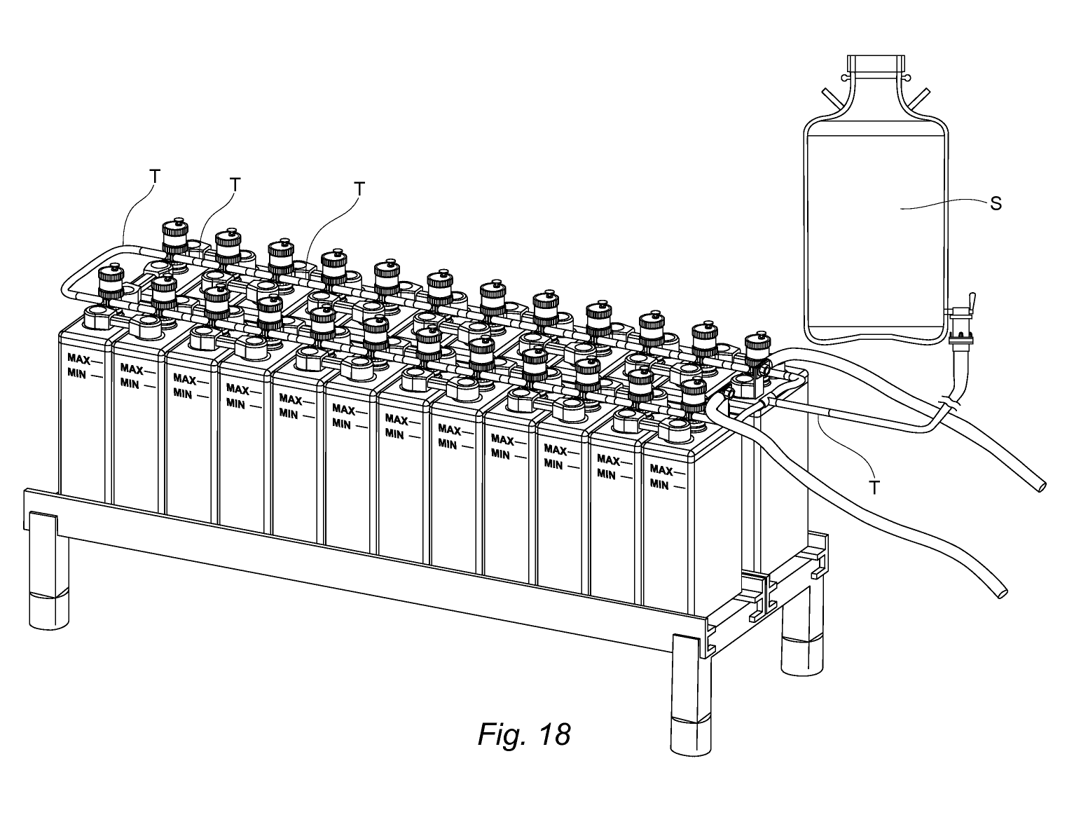

FIG. 18 is a perspective view of a battery provided with the topping up assembly according to the invention.

FIGS. 6 and 7 show altogether two plugs according to the invention, with dome-shaped filter and with cylindrical filter, respectively.

In the following detailed description it will be understood that, unless differently specified, the materials and the building techniques of the individual components are substantially correspondent to the prior-art ones illustrated above.

A plug with cylindrical filter according to the invention is shown in FIGS. 7-11.

With reference to FIG. 9, it is pointed out that the plug comprises a substantially hollow plug body 40, generally made of plastic material, which acts also as a base for filter element 41. Ceramic filter 41 is in the shape of a cylindrical wall which may be made, for example, of two different materials: silicon carbide or corundum, with different granulometric characteristics depending on use requirements. The height of filter 41 may vary, thus determining the area of the porous surface and hence the flow rate of the gases it is capable of disposing. Cylindrical filter 41 is welded between a cap 42 and a lower flange 43 belonging to plug body 40, both made of plastic material. The welding process occurs under heat and under pressure.

For such purpose, in the inner contact areas of filter 41, cap 42 and flange 43 are advantageously provided with three welding directrices 42a and 43a (FIGS. 11A and 11B) in the form of concentric, circumferential (triangular-section) ridges. The three circumferential ridges have a diameter ranging between the outer diameter and the inner diameter of ceramic filter 41, and are manufactured by integral moulding with cap 42 and with flange 43.

During pressure welding of parts 42 and 43, with filter 41 in between, directrices 42a and 43a, softened by heat, enter the circular crown base of the filter. Due to the particular shape of the directrices, with a cusp vertex, a perfect welding of the parts is obtained.

Cap 42 and flange 43 have a striped or knurled outer surface which makes the handling of the entire plug more effective.

In the central part of the plug an automatic topping up arrangement of the distilled water is obtained, which is better illustrated in the following.

Inside hollow body 40 a topping up bowl V is obtained, connected to the outside through two orientable connections 44a and 44b.

From bowl V a transfer conduit V₁ departs, which puts in communication bowl V with the underlying cavity of body 40, which further has a delivery opening 40a for the inward flow of the battery element. Preferably, conduit V₁ rises by a short measure from the bottom of bowl V, so that a permanent level of the topping up liquid inside bowl V is established.

Conduit V₁ ends below with an outlet nozzle V₂ intended to be closed by a rubber plug 50 mounted movable on a float system. In particular, rubber 50 is integral with an articulated rod 51 which is constrained in rotation about a hinge 52, or simply a wedge abutment, integral with the wall of body 40. At the opposite end, articulated rod 51 is connected to a fork lever 53 through a shaft/hole coupling 54.

Fork lever 53 is L-shaped, as visible in FIGS. 11A and 11B, and is guided in a vertical translation motion by a gasket ring 54 mounted at the bottom of a lower sleeve 55 of body 40.

At the lower end of L-shaped lever 53, a small rod 53a is provided, which is made integral with a float 56, intended to float on the electrolyte liquid inside the accumulator element.

During operation, articulated rod 51 receives an upward thrust by lever 53—in turn pushed upwards by float 56—which forces it to rotate around hinge or wedge 52. In this rotation movement, articulated rod 51 pushes rubber 50 to close nozzle V₂, so as to prevent the entry of the topping up liquid contained in bowl V₁. The relative size of the components and the mounting position of the plug on the accumulator element are such that, when the electrolyte liquid level is above the minimum desired level, the thrust on the float maintains nozzle V₂ closed (FIG. 11B). Vice-versa, when the electrolyte level drops below the minimum, float 56 drops and, consequently, rubber 50 moves away from nozzle V₂, opening the outlet of topping-up liquid F (typically distilled water) from bowl V (FIG. 11A).

The lever arm is thus defined to exploit as much as possible the useful room in the plug, transferring onto the closing point of nozzle V₂ a force equal to about 7 times the Archimedean thrust supplied by the electrolyte liquid onto the float.

According to a preferred variant, the plug with cylindrical filter according to the invention is arranged for the introduction of a probe (densimeter, thermometer, or other) to be able for checking the physical conditions of the electrolyte without having to disassemble the plug from its seat.

For such purpose, upper cap 42 is provided with a vertical channel 42a (FIG. 8B), which runs within cylindrical filter 41 and is aligned with a hole 43a and with an opening in the lower part of body 40 which opens towards the inside of the accumulator element.

In normal operating conditions, conduit 42a is intended to be closed by a closing pin 48, provided with one or more circumferential gaskets and pressure-coupled within conduit 42a.

Should one have to insert the desired probe, for example the densimeter shown in FIG. 8B, it is sufficient to remove pin 48 from conduit 42a, by acting on a handle 48a thereof, and to introduce the rectilinear probe which may run entirely across the plug until it descends beyond float 56. In order to limit the radial dimensions of the plug, conduit 42 is arranged at a shorter radial distance from the symmetry axis than the diameter of float 56; said float, however, has a side recess suitable to let the probe pass through, which probe is introduced into the accumulator element.

According to a further preferred variant, plug body 40 is introduced snapwise into a lower cup coupled with the accumulator seat. For such purpose, the lower part of body 40 is shaped as a flexible cylindrical wall 49, for example provided with longitudinal notches 49b. At the mouth of cylindrical wall 49 an annular bevelled relief 49a is provided, which ensures that body 40 cannot disengage from the lower cup once snap-coupled therewith.

Also, the lower cup has a cylindrical wall 46 whereon bayonet-type reliefs for the double-bayonet engagement with the corresponding opening/seat of the accumulator are formed. In the upper part the cup has a preferably notched locking ring 45, beneath which an annular gasket 47 is arranged, intended to seal against the edge of the accumulator seat.

Between the cup and plug body 40 a toroidal gasket O, such as an O-ring, is preferably arranged, which ensures a more stable coupling between these two parts.

FIGS. 13A-13C and 14 show various views of the cup according to the invention.

The snap mounting between plug body 40 and the underlying coupling cup in the accumulator seat allows to easily enclose between them connections 42a and 42b for water inflow and outflow, thereby guaranteeing the free orientation thereof. As a matter of fact, the opportunity to freely orientate the two connections 42a and 42b is important for the connection of the various plugs of a battery, as will be shown below.

A second advantageous result is that of maintaining the plug unconstrained in rotation from the cup. This is useful during the final assembly phase, as will be shown further on.

FIG. 12 shows instead a dome-shaped cap according to the invention. All the components are identical to the ones described above, except for the upper part of the plug. As a matter of fact, above flange 43 of body 40 only a dome-shaped filter 41′, known per se, is applied. The connection of filter 41′ to flange 43 may be obtained by the method indicated above, here too exploiting three cylindrical cusp-shaped directrices to promote welding.

FIG. 15 shows the way of introduction of a plug according to the invention into the seat of an accumulator element.

Once the plug has been introduced into the suitable housing, it is provided to fully tighten the double-bayonet cup part, acting on locking ring 45. Due to the notches obtained on locking ring 45, it is possible to perform the tightening with the help of a suitable key (FIG. 17A), also of plastic material, such as the one shown in FIG. 16. The tightening occurs by screwing locking ring 45 in a clockwise direction, until adequate compression of gasket 47 on the mouth of the housing seat is accomplished, so as to guarantee a good seal.

Thereby, the plug is securely fastened to the battery element, but the upper part—due to the snap coupling with the cup part—maintains the ability to rotate with respect to the accumulator seat: it can therefore be acted upon to orient the plug manually (FIG. 17B) and to arrange connections 44a and 44b on the side providing easiest access for the subsequent connection operation.

All adjacent connections are put in communication by small connecting pipes T (FIG. 18), so as to connect in series all the topping up bowls V of the individual plugs of the various battery elements.

Thereby a system of pressurised communicating vessels is created. The communicating vessels are indeed the accumulator elements. Circuit pressure is determined by the piezometric height of a storage tank S of the topping up liquid (distilled water) whereto the system is connected.

Evidently, tank S may be positioned in a desired, easily accessible location.

As can be understood, therefore, with the above-described plug the objects set forth in the preliminary remarks may be achieved. As a matter of fact, a filter plug has been provided, either cylindrical or dome-shaped, which does not require awkward or time-consuming operations to perform the topping up, but which simply requires to keep the piezometric level of an easily-accessible single tank up-to-date.

There is hence no need for continuous support for the visual monitoring of the electrolyte level in all the elements forming the electric accumulator. This determines a reduced presence of the operator and a resulting increased safety of maintenance personnel.

Finally, the specific configuration and construction ensures a general inexpensiveness and ease of assembly.

However, it is understood that protection of the above-described invention is not limited to the particular embodiments shown, but extends to any other equivalent construction variant as defined in the attached claims.

1. Venting plug for stationary batteries, of the type comprising a support body, which may be screwed into an upper opening of a battery element, provided with at least one topping-up hole intended to cause an electrolyte topping-up liquid to precipitate into the battery element which liquid is introduced into the upper part of said support body, and further comprising a porous element, mounted in the upper part of said support body, intended to act as a filtering barrier for the gases which rise up from said battery element towards the outside along said topping-up hole, characterised in that said support body has inside a topping-up bowl, communicating with two inlet and outlet connections, provided with an upwardly-protruding conduit which opens below the bowl into an outlet nozzle, and in that below the bowl there is provided a hermetic closing element of said nozzle controlled by a float assembly which leads said closing element to obstruct said nozzle when the electrolyte level lies above a preset operational level.

2. Venting plug for stationary batteries as claimed in claim 1, wherein a lower cup provided with coupling means intended to cooperate with similar coupling means in the upper opening of the battery element is further provided, said cup being apt to be snap-coupled with the support body, so as to define a mutual axial constraint, but free mutual rotation.

3. Venting plug for stationary batteries as claimed in claim 2, wherein said inlet and outlet connections may be oriented and are rotatably sandwiched between an upper flange portion and a lower flange portion, to be moved closer to each other during mounting, the upper one integral with the support body and the lower one integral with the lower cup.

4. Venting plug for stationary batteries as claimed in claim 3, wherein said lower flange is part of a locking ring of the lower cup.

5. Venting plug for stationary batteries as claimed in claim 4, wherein said locking ring is provided with a notched surface which may be coupled with a respective tightening key.

6. Venting plug as claimed in claim 1, wherein said porous element is shaped as a hollow ceramic body, hot-pressure-welded on a support portion of the plug body.

7. Venting plug as claimed in claim 6, wherein said support portion of plastic material has a plurality of circumferential and concentric ridges apt to enter, in a heated condition, the ceramic material.

8. Topping-up assembly for a stationary battery, comprising a plurality of plugs as claimed in claim 1, characterised in that each plug is connected with two adjacent plugs by pipes leading to said inlet and outlet connections, respectively, the circuit comprising said plugs and relative pipes further being connected to a topping-up liquid tank apt to establish a desired piezometric height of topping-up liquid for said circuit.
